(19) United States
(12) Patent Application Publication
(10) Pub. No.: US 2009/0007637 A1
(43) Pub. Date: Jan. 8, 2009

(54) GAS SENSOR

(75) Inventors: Chen-Chia Chou, Taipei City (TW); Tsung-Her Yeh, Taipei City (TW)

Correspondence Address: QUINTERO LAW OFFICE, PC, 2210 MAIN STREET, SUITE 200, SANTA MONICA, CA, 90405, US

(73) Assignee: NATIONAL TAIWAN UNIVERSITY OF SCIENCE & TECHNOLOGY, TAIPEI CITY (TW)

(21) Appl. No.: 12/168,095

(22) Filed: Jul. 4, 2008

(30) Foreign Application Priority Data
Jul. 6, 2007 (TW) TW96124635

(51) Int. Cl. G01N 27/62

(52) U.S. Cl. 73/31.05

(57) ABSTRACT

A gas sensor is provided. The gas sensor includes a substrate, a first electrode, a second electrode, a power source and a current meter. The substrate includes a planar surface, wherein the substrate is made of ion-conductive material, proton-conductive material or electron-conductive material. The first electrode is formed on the planar surface. The second electrode is formed on the planar surface, wherein a gap is formed between the first electrode and the second electrode. The power source is electrically connected to the first electrode and the second electrode, wherein the power source provides a voltage to the first electrode and the second electrode. The current meter is electrically connected to the first electrode and tie second electrode to measure a limit current passing the first electrode and the second electrode.

### CROSS REFERENCE TO RELATED APPLICATIONS

This Application claims priority of Taiwan Patent Application No. 096124635, filed on Jul. 6, 2007, the entirety of which is incorporated by reference herein.

### BACKGROUND OF THE INVENTION

1. Field of the Invention

The present invention relates to a gas sensor, and in particular relates to an oxygen sensor.

2. Description of the Related Art

FIG. 1 shows a conventional oxygen sensor 10, comprising a first electrode 11, a second electrode 12, an electrolyte layer 13, a chamber 14, a power source 15 and a current meter 16. The power source 15 is electrically connected to the first electrode 11 and the second electrode 12. The current meter 16 is parallel connected to the power source 15. The first electrode 11 and the second electrode 12 are formed on opposite surfaces of the electrolyte layer 13. The first electrode 11 is in the chamber 14. The chamber 14 comprises an opening 17. During gas detection, the power source 15 provides a voltage, and the oxygen gas enters the chamber 14 through the opening 17. A redox reaction occurs at the first electrode 11, and ions, protons and/or electrons 18 of the electrolyte layer travel from the first electrode 11 to the second electrode 12 to generate a limit current. The current meter 16 measures the limit current to define environmental oxygen consistency.

Conventionally, thickness of the electrolyte layer 13 effects sensitivity of the oxygen sensor 10. Sensitivity of the oxygen sensor 10 increases when the electrolyte layer 13 is thinner. However, the electrolyte layer 13 is fragile, thus it is difficult to further decrease thickness. Additionally, modifying thickness of the electrolyte layer 13 increases costs.

### BRIEF SUMMARY OF THE INVENTION

A detailed description is given in the following embodiments with reference to the accompanying drawings.

In one embodiment, a gas sensor is provided. The gas sensor comprises a substrate, a first electrode, a second electrode, a power source and a current meter. The substrate comprises a planar surface, wherein the substrate is made of ion-conductive material, proton-conductive material or electron-conductive material. The first electrode is formed on the planar surface. The second electrode is formed on the planar surface, wherein a gap is formed between the first electrode and the second electrode. The power source is electrically connected to the first electrode and the second electrode, wherein the power source provides a voltage to the first electrode and the second electrode. The current meter is electrically connected to the first electrode and the second electrode to measure a limit current passing the first electrode and the second electrode.

In a modified embodiment, a gas detection method is provided, which comprises the following steps. First, the gas sensor is provided. Next, a gas is provided and contacts the gas sensor. Then, the voltage is applied to the first electrode and the second electrode with the electronic source, wherein the gas is ionized at the first electrode to generate a plurality of ions, protons or electrons, and the ions, protons or electrons permeate the substrate to conduct the first electrode and the second electrode. Finally, the limit current passing the first electrode and the second electrode is measured by the current meter.

In the embodiment of the invention, sensitivity of the gas sensor can be modified by modifying the gap which is between the first electrode and the second electrode. The gas scale can be easily controlled. Therefore, the invention provides a highly sensitive gas sensor through a cheaper and more convenient method.

### BRIEF DESCRIPTION OF THE DRAWINGS

The present invention can be more fully understood by reading the subsequent detailed description and examples with references made to the accompanying drawings, wherein:

FIG. 1 shows a conventional oxygen sensor;

FIG. 2 shows a gas sensor of an embodiment of the invention;

FIG. 3 shows a modified embodiment, wherein the first electrode and the second electrode are interdigital electrodes; and

FIG. 4 shows a gas sensor of another embodiment of the invention.

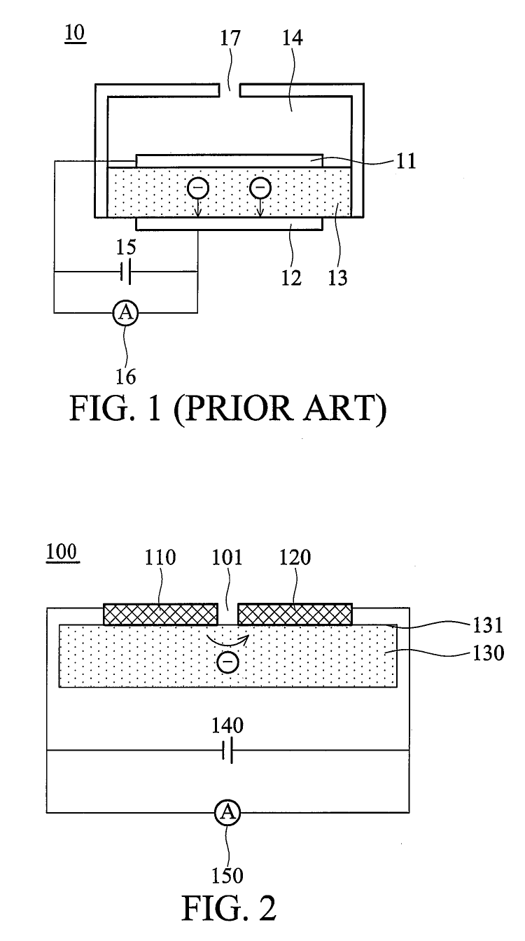

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

FIG. 2 shows a gas sensor 100 of an embodiment of the invention, comprising a first electrode 110, a second electrode 120, a substrate 130, a power source 140 and a current meter 150. The substrate 130 comprises a planar surface 131. The substrate 130 is made of ion-conductive material, proton-conductive material and/or electron-conductive material. The first electrode 11 and the second electrode 120 are formed on the planar surface 131. A gap 101 is formed between the first electrode 110 and the second electrode 120. The power source 140 is electrically connected to the first electrode 110 and the second electrode 120, and applies a voltage thereto. The current meter 150 is parallel connected to the power source 140 to measure a limit current passing the first electrode 110 and the second electrode 120.

The first electrode 110 and the second electrode 120 contacts oxygen in the air. When the power source 140 applies the voltage, oxygen is ionized into oxygen ions at the first electrode 110. The oxygen ions partially permeate into the substrate 130, and bring the electrons to the second electrode 120. The second electrode 120 reduces the oxygen ions into oxygen. When environmental oxygen consistency is high, the action mentioned above speeds up, electrons traveling from the first electrode 110 to the second electrode 120 increase, and the limit current increases. Therefore, by measuring the limit current with the current meter 150, the gas sensor 100 of the embodiment may define environmental oxygen consistency.

The sensitivity of the gas sensor 100 can be modified by controlling the lateral diffusion gap 101 of the ion, proton and/or electron. Because the lateral diffusion gap 101 can be easily controlled, a highly sensitive gas sensor 100 can be easily realized.

The substrate 130 can be made by a thick film process, such as a screen print, dry press, inject or scrape process. The substrate 130 also can be made by a thin film process of Micro Electro-Mechanical Systems, such as a lift-off or etching process.

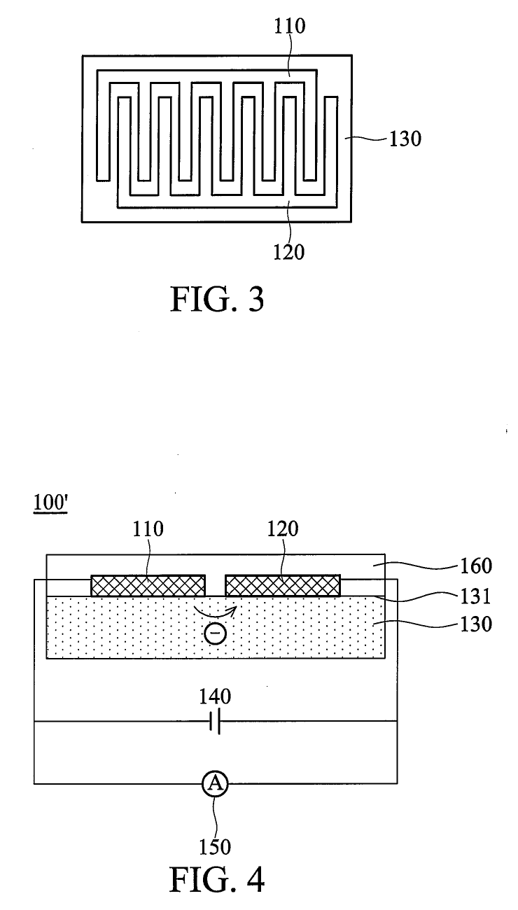

With reference to FIG. 3, in a modified embodiment, the first electrode 110 and the second electrode 120 are interdigital electrodes. The first electrode 110 corresponds to the second electrode 120. When interdigital electrodes are utilized, the gas sensor 100 has improved sensitivity and increased sensing area, which can generate greater induced electromotive force. The first electrode 110 and the second electrode 120 can be made by a thick film process, such as a screen print, inject print or spread process. The first electrode 110 and the second electrode 120 can be made by a thin film process of Micro Electro-Mechanical Systems, such as a lift-off or etching process. When the first electrode and the second electrode are formed by the screen printer, a line space between the first electrode and the second electrode is decreased to 0.1 mm. When the first electrode and the second electrode are formed by the lift-off process, a line space between the first electrode and the second electrode is decreased to 10 82 m to 20 nm. The gas sensor of the embodiment can be produced by a cheap and easy planar process to decrease costs and time.

The ion-conductive material, proton-conductive material or electron-conductive material can comprise cerium oxide or zirconium oxide mixed with positive ion with +2 or +3 charges. The ion-conductive material, proton-conductive material or electron-conductive material can also be LaMo₂O₉ or Perovskite.

FIG. 4 shows a gas sensor 100′ of another embodiment of the invention, which further comprises a gas diffusion layer 160. The gas diffusion layer 160 covers the substrate 130, the first electrode 110 and the second electrode 120.

The first electrode 110 and the second electrode 120 can comprise the following materials: (a) metal materials such as Pt, Au, Pd, Rh, Ir, Ru, Os, Ni, Co and Fe which can easily electrical-chemical react with oxygen; (b) Perovskite ceramics such as LaSrMnO₃ and LaSrCoFeO₃, which can easily electrical-chemical react with oxygen; (c) a combined material comprising the metal materials and the Perovskite ceramics mentioned above and zirconium oxide to provide ion-conduction and electron-conduction; (d) a second phase material for resisting carbonization, poisoning or vulcanization, such as copper or cerium oxide.

In a sintering process and a heat treatment of the gas sensor of the invention, an electric furnace, atmosphere furnace, microwave sintering furnace, laser annealing and heat press are utilized to calcine elements and sinter (jointly or separately) the electrolyte and the interdigital electrodes. When a thin film process is utilized to sinter and heat-treat the gas sensor, the sintering temperature thereof is about 600° C. to 800° C. When a thick film process is utilized to sinter and heat-treat the gas sensor, the sintering temperature thereof is about 1300° C. to 1600° C.

The gas diffusion layer can comprise the following materials: (a) magnesium aluminate spinel; (b) lanthanum aluminum oxide; (c) a second phase material for resisting carbonization, poisoning or vulcanization, such as copper or cerium oxide.

The gas sensor of the embodiments of the invention can be produced by a planar process or a semiconductor process to decrease costs and be mass produced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A gas sensor, comprising:
a substrate, comprising a planar surface, wherein the substrate is made of ion-conductive material, proton-conductive material or electron-conductive material;
a first electrode, formed on the planar surface;
a second electrode, formed on the planar surface, wherein a gap is formed between the first electrode and the second electrode;
a power source, electrically connected to the first electrode and the second electrode, wherein the power source provides a voltage to the first electrode and the second electrode; and
a current meter, electrically connected to the first electrode and the second electrode to measure a limit current passing the first electrode and the second electrode.

2. The gas sensor as claimed in claim 1, wherein the current meter is parallel connected to the power source.

3. The gas sensor as claimed in claim 1, wherein the ion-conductive material, the proton-conductive material or the electron-conductive material is selected from a group of zirconium oxide, cerium oxide, LaMo₂O₉ and Perovskite.

4. The gas sensor as claimed in claim 1, wherein the first electrode and the second electrode are interdigital electrodes.

5. The gas sensor as claimed in claim 1, further comprising a gas diffusion layer, wherein the gas diffusion layer covers the substrate, the first electrode and the second electrode.

6. The gas sensor as claimed in claim 1, wherein the first electrode and the second electrode comprise material selected from a group of Pt, Au, Pd, Rh, Ir, Ru, Os, Ni, Co and Fe.

7. The gas sensor as claimed in claim 1, wherein the first electrode and the second electrode comprise Perovskite.

8. The gas sensor as claimed in claim 1, wherein the first electrode and the second electrode comprise LaSrMnO₃.

9. The gas sensor as claimed in claim 1, wherein the first electrode and the second electrode comprise LaSrCoFeO₃.

10. The gas sensor as claimed in claim 1, wherein the first electrode and the second electrode comprise Cu.

11. The gas sensor as claimed in claim 1, wherein the first electrode and the second electrode comprise cerium oxide.

12. The gas sensor as claimed in claim 5, wherein the gas diffusion layer comprises magnesium aluminate spinel.

13. The gas sensor as claimed in claim 5, wherein the gas diffusion layer comprises lanthanum aluminum oxide.

14. The gas sensor as claimed in claim 5, wherein the gas diffusion layer comprises copper.

15. The gas sensor as claimed in claim 5, wherein the gas diffusion layer comprises cerium oxide.

16. A gas detection method, comprising:
providing the gas sensor as claimed in claim 1;
providing a gas, wherein the gas contacts the gas sensor;
applying the voltage to the first electrode and the second electrode with the electronic source, wherein the gas is ionized at the first electrode to generate a plurality of ions, protons or electrons, and the ions, protons or electrons permeate the substrate to conduct the first electrode and the second electrode; and
measuring the limit current passing the first electrode and the second electrode by the current meter.

17. The gas detection method as claimed in claim 16, wherein the gas is oxygen, and the ions are oxygen ions.

18. The gas detection method as claimed in claim 16, further comprising modifying the gap to control sensitivity of the gas sensor.
